(19) United States
(12) Patent Application Publication
(10) Pub. No.: US 2005/0021495 A1
(43) Pub. Date: Jan. 27, 2005

(54) System and method for tracking environmental emission reductions

(76) Inventors: John A. McMorris III, Indialantic, FL (US); Alan R. Tank, Bethesda, MD (US); Shayne A. Reeb, Vero Beach, FL (US)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 10/720,777

(22) Filed: Nov. 24, 2003

Related U.S. Application Data
(60) Provisional application No. 60/429,267, filed on Nov. 26, 2002.
(60) Provisional application No. 60/440,069, filed on Jan. 13, 2003.
(60) Provisional application No. 60/498,992, filed on Aug. 29, 2003.
(60) Provisional application No. 60/513,498, filed on Oct. 22, 2003.

(51) Int. Cl. G06F 7/00

(52) U.S. Cl. 707/1

(57) ABSTRACT

A system for tracking environmental performance of a producer of environmental emissions and of associating individual environmental emission reductions to the producer, to a variety of collected data, or both includes selecting a production practice of the producer and an appropriate protocol for converting the production practice to a measure of environmental emissions. An identifier for each quantifiable unit of environmental emissions a sequence portion characterizing a succession of units, a vintage portion characterizing the time period for the production practice, a protocol characterizing portion and a geographical reference portion. Such an identifier allows for a tracking of the processes that resulted in the environmental emissions measurement.

### CROSS-REFERENCE TO RELATED APPLICATIONS

This U.S. Application claims priority to U.S. Provisional Patent Applications having Ser. No. 60/429,267 filed Nov. 26, 2002 for “Environmental Emissions Management System and Method,” 60/440,069 filed Jan. 13, 2003 for “Environmental Emissions Management System and Method,” 60/498,992 filed Aug. 29, 2003 for “System and Method for Creating Emission Credit Serial Numbers and Enabling Data Transparency”, 60/513,498 filed Oct. 22, 2003 for “System and Method of Creating, Aggregating, and Transferring Agriculturally-Sourced Environmental Emission Reduction Credits,” and U.S. Utility Patent Application filed of even date, Nov. 24, 2003 for “System and Method of Creating, Aggregating, and Transferring Environmental Emission Reductions,” the disclosures of which are hereby incorporated herein by reference.

### FIELD OF THE INVENTION

The present invention relates to environmental emissions, and in particular to tracking the environmental performance of a producer of environmental emission reductions.

### BACKGROUND

Environmental emissions are the subject of increasing scrutiny in many industries and municipalities, and are becoming regulated at both the regional and national level. To an increasing extent, business site permits are being used to augment regional policies by requiring pollutant mitigation for air, water, and/or soil.

Policy makers face a seemingly insurmountable dilemma: continuing economic growth/recovery requires expanded energy production and economic output, which leads directly to increased environmental emissions levels—but environmentalists are clamoring for definitive actions to reduce environmental emissions and for a greener environment. This is especially true in the area of Climate Change, wherein environmentalists are seeking wide-ranging reductions in the emissions of greenhouse gases (GHG).

The problem is acute; solutions that mandate energy caps will lead to a head-on collision with industry and may have grave economic consequences; but global emission problems are big. In the GHG area, for instance, existing legislation/accords contemplate worldwide reductions of roughly 2 billion tons (of CO₂ equivalent) annually; furthermore, to stabilize the atmosphere at scientifically recommended CO₂ levels will require worldwide reductions exceeding 10 billion tons per year.

In general, environmental emission reductions can be achieved through abatement techniques (such as installing smokestack scrubbers or by making widespread capital upgrades), by enhancing or eliminating industrial operations that generate significant environmental emissions (future technology is likely to manifest more efficient operations), or by a variety of removal techniques that “scrub” pollutants from the biosphere. Techniques that avoid the production of environmental emissions or that actively reduce existing pollution levels (either technique must be measurable and verifiable and compared to an established baseline) can be used to create environmental emission reduction units.

Industry is seeking effective, inexpensive, and reliable means to offset environmental emissions for the next 30 years or more, until emerging processes and new capital equipment “catch up” to the emissions problem. What is more, to be economically sustainable, the solution(s) will require that large emitters (such as utilities) have a ready, reliable, long-term access to a large aggregated supply of emission reductions that can be used to offset their emissions. Further, emitters need transparent means to confirm that emission reductions used as offsets are “real,” to establish they are properly satisfying their compliance requirements.

Complicating the process of creating, aggregating and transferring (selling) environmental emission reductions, few formal standards have been promulgated to specify these steps or to provide reference baselines. Until the recent past, for instance, a putative purchaser of environmental emission removals and a “qualified” supplier of such removals worked together on an ad hoc basis, mutually defining the characteristics of a particular supply contract. The environmental emission reductions were created to mutually determined (private) standards, were sometimes inspected or verified by 3^{rd} party agencies, such as environmental engineers, environmentalists, or accounting firms, and were privately exchanged. These trades were executed on a project-by-project basis, and were often shrouded in secrecy—unless the buyer desired to publicize the event to garner positive Public Relations value. Even when such trades are handled with integrity, however, the opacity of the process stirs concerns about improper reconciliation against emission requirements and fears that environmental emission removals are being improperly sold and/or retired.

Various notional approaches have been proposed for implementing national trading and data recording schemes for environmental emissions credits, and fledgling systems are being developed in several countries. Most of these trading schemes promote the development and use of a data “Registry”, which is used to register specific environmental emissions and environmental emissions reductions. In some cases, the Registry will make a putative serial number assignment (for environmental emission reductions); in other cases, private entities make these assignments. Most often, these Registries will be used to satisfy several needs, including the reconciliation of emissions with environmental emission reductions (when emission reductions are used to offset specific emissions or to satisfy specific emission compliance requirements), to register the “retirement” of individual units of environmental emission reductions (when they are used to offset emissions or may no longer be used as offsets, for administrative or regulatory reasons), and to enable governmental agencies, non-governmental organizations (NGOs) such as environmentalist organizations, and the public to better understand the process used to qualify, quantify, and record specific data attendant to the identification and recording of environmental emission reductions.

Unfortunately, standards for serialization and registration are sketchy and inconsistent. While recent regional and sub-national climate change legislation establishes reference baselines, against which emissions levels can be specified it does not unambiguously specify how to qualify/quantify GHG environmental emission reductions, registration mechanisms and standards, by way of example.

In addition, projects for creating/supplying environmental emission reductions often lack adequate quality assurance provisions. For instance, even for those trades that impose some level of quality control—such as site audits or data verification—no means has been used (beyond the integrity/certification of the company or individual auditor, that is) to actually prove that a site audit took place. In many instances records are paper based and are not secured.

Emitters, governance jurisdictions, NGOs, and verifiers need ready, inexpensive, transparent means to confirm the environmental performance of a producer of environmental emission reductions and to correlate data about the methodology and processes used to qualify and quantify such environmental emission reductions. Moreover, industry needs means to track individual units of environmental emission reductions to preclude “double selling” of same unit(s), and to facilitate proper reconciliation of emitter compliance (offset) requirements through an environmental emission reduction unit retirement process.

### SUMMARY

In view of the foregoing background, embodiments of the present invention provide a system for tracking environmental performance of a producer of environmental emissions and of associating individual environmental emission reductions to the producer and/or to a variety of collected data.

One method of tracking environmental performance of a producer of environmental emissions may include selecting a production practice of the producer and selecting a protocol applicable with the production practice for determining environmental emissions and/or environmental emissions removal. Production practice data of the producer may be collected for a pre-selected time period responsive to the protocol. The production practice data is then converted to environmental data using pre-selected conversion factors such as those compatible with or available from the protocol. The environmental data may then be converted to an emission reduction unit. An identifier is identified with each of the environmental data and/or the emission reduction units, wherein the identifier includes a sequence portion characterizing a succession of units and a vintage portion characterizing the pre-selected time period for the production practice, and may include a protocol characterizing portion and/or a geographical reference portion.

Such a system complements the use of sound foundational science used to qualify and quantify environmental emission reductions and removals, and provides means to associate registered producer environmental emission reduction units with data used to qualify and quantify the environmental emission reduction, to ascertain a producer's production baseline (of value when governance bodies are considering baseline policy changes), and for qualified entities such as third party verifiers to access all pertinent information relating to the qualification and quantification of the environmental emission reductions including data that may have been optionally encrypted. It also provides means for prospective customers to identify and/or reserve environmental emission reductions meeting specific sort criteria, to reconcile emitter emissions with use of emissions offsets, and to record and track environmental emission reductions unit retirement.

An embodiment of the invention includes selecting a production practice, selecting a protocol applicable with the production practice for determining at least one of environmental emissions and environmental emission reductions/removals, collecting production practice data for a pre-selected time period responsive to the protocol, converting the production practice data to environmental data using pre-selected conversion factors, designating a geographical reference for the production practice, and assigning an identifier to resulting environmental emission reduction units.

An embodiment of the invention includes selecting at least one production practice from at least one of a plurality of production sectors including agriculture, forestry, petroleum and/or gas production (including enhanced oil recovery), fuel production (including ethanol production), semiconductor manufacturing, metal production, coal production, deep geologic sequestration, durable goods manufacturing, and waste management (including landfills).

An embodiment of the invention includes selecting a protocol appropriate to the production practice, collecting available external information sources regarding the producer and its operations, and may include having a producer warrant the data and/or data collecting process. Specific protocols may acknowledge or document the production of co-benefits along with the generation of environmental emission reductions.

Methods may include collecting production practice data, which are later processed to qualify and quantify environmental emission removal units. The collecting of production practice data may include gathering externally available information and onsite data regarding the producer.

One embodiment may include forming an assessment team for collecting information regarding the production practice(s), the protocol(s), and prerequisite qualifications and certifications for assessors. Data collecting equipment may include the use of electronic data instruments that may enhance the process of collecting and transferring data in a reliable, efficient manner. It is possible to use such electronic data instruments to collect a producer's warrant that proper site data collecting and security procedures were followed, which forms the basis of a release of legal liability relative to specific issues. In the case of an agricultural producer, for instance, this warrant can certify that a data collecting entity followed proper bio-security protocols. For any production practice, this warrant can certify that data provided by the producer is accurate and complete.

In an embodiment of the invention, the pre-selected time period may comprise a calendar year for the production practice. It will be most important to be able to identify the production practice pre-selected time, as different environmental emission offset trading regimes are likely to have differing usage and/or reconciliation requirements relative to use of environmental emission reductions produced contemporaneously or in the past. Even in the absence of restrictions, however, buyers may assign higher market value to “newer” environmental emission reductions. As well, this feature will also be of use for specific types of environmental emission reductions, wherein “permanence” is an issue, as it may be necessary to apply a temporal conversion predicated upon “permanence” curves wherein the value on an environmental emission removal unit declines as a function of time.

In one method embodiment practice data converting may include the protocol having conversion factors selected from the group including GHG emissions, providing clean water credits, providing clean air credits, providing soil erosion credits, and certifying animal welfare or other commercial production compliance standards.

Converting the effective environmental data to an environmental emission reduction includes converting to an offset, credit, or allowance, depending on restrictions imposed by the relevant environmental (emission) regime, and may include choosing a registry (or registering) jurisdiction, including to enable the “use” of the environmental emission reductions in a particular jurisdiction.

In another embodiment of the invention, the geographical reference includes a location representative of the production practice. This reference can include a nominal site location, a building or field location, or the legal address of the production practice. A buyer may desire to favor environmental emission reduction supply from a particular region or producer for public relations purposes. By the same token, a buyer may be unable to use environmental emission reductions from other geographic locations for reasons of regulation or policy. A geographical reference can be used by the system to associate or reserve specific environmental emission reductions capacity for specific use. The geographical reference may be identified by longitude and latitude, by way of example.

In another embodiment, the collecting of production practice data may include the contemporaneous recording of the time the data was recorded. This makes it possible for the system to plot at least one of time and/or geographic location for data collecting, which can be of great use to third party verifiers or other entities wanting to review the data collecting process.

An identifier may include a sequence portion characterizing a succession thereof, a vintage portion characterizing a pre-selected time period for the production practice, and a characterizing portion distinguishing at least one of geographical reference and the protocol. In this manner, individual units (or sub-units) of environmental emission reductions can be uniquely enumerated, including the year the production practice was undertaken, and additional references such as geographic reference that can be associated with an individual producer. As earlier noted, such enumeration may have keen value to buyers who desire to use environmental emission reductions from specific sources or classes of sources. The system also has the capacity to identify and/or reserve environmental emission reductions with specific sequence attributes.

In another embodiment of the invention one or more of the sequences, such as the geographic reference may be encrypted. This feature could be used to protect the privacy of specific producers, for instance, from all except those entities who are authorized to receive decrypted data. This feature could also be used to prevent one entity from “poaching” producer suppliers from another entity that seeks to have producer suppliers of environmental emission reductions.

Further, the characterizing portion of the identifier may include at least one of a first field identifying a protocol type, a second field identifying a version of the protocol, and a third field identifying an authority for the protocol. As earlier noted, specific enumeration of environmental emission reductions may be quite valuable to specific buyers. For example, the protocol type will directly or indirectly identify the production practice responsible for creating the environmental emission reduction. As well, a specific protocol version may, for example, treat data variance or data collection and/or monitoring (or some other attribute specified by the protocol) in a “preferable” way (viewed from the perspective of the buyer). Lastly, a field identifying approval authority enables a buyer to choose environmental emission reductions that have been approved by a specific entity, such as a government or the World Bank. Forearmed with this knowledge, a buyer could selectively choose to purchase specific environmental emission reductions, to complement a business typology, a compliance philosophy, to favor a given approval authority, or so forth.

In yet another embodiment of the invention, the environmental emission reduction comprises a plurality of environmental emission reductions resulting from the environmental data converting, wherein a sequence portion of the identifier includes a range of sequence numbers representing the plurality of environmental emission reduction units.

The system may include transferring the production practice data to a data center, wherein transferring data may include transmitting and/or encrypting the production practice data, and receiving the production practice data, which may include decrypting the production practice data and/or securing the data and restricting access.

Methods may include confirming that the received production practice data meets a pre-selected data standard, including data integrity, data completeness, storing the data and/or associated identifier in a database, testing the production practice data's eligibility for processing, such tests including reviewing for non-conforming processes, and correlating the production practice data with the identifier for access thereto.

Method steps within an embodiment of the invention may include converting the effective environmental data and registering the effective environmental data to an environmental emission removal unit. Registering of data may include verifying the commercial suitability of the effective environmental data, recording the registering, designating the ownership of the environmental emission removal unit, assigning a unique identifier, which may be a protocol related identifier, may provide either temporal or spatial information regarding the production practice that caused the environmental emission reduction unit to be created (including geo-referenced coordinates), may include specific emission removal unit accounting, or which may include full or partial encryption, and includes the case wherein a unique identifier may consist of a serial number, which may be derived relating to such parameters as those mentioned herein.

The system may be used to associate an externally assigned identifier to internal data and/or identifiers. In addition, all collected data relative to one or more environmental emission removal units may be correlated.

Methods may include selling, transferring, or retiring the environmental emission reduction unit(s). One method may comprise transferring the emission reduction unit for offsetting at least a portion of an environmental emission.

The system can be queried by authorized entities, such as third party verifiers or customers, to determine and report on specific production practice data, associated identifiers, and/or associated environmental emission reductions, or on compliance issues, relating any production practice data contained in the data warehouse or available through external sources. This capability may be a “for fee” service.

The taking of title to the effective environmental data by an entity other than the producer makes it possible to sever producer reliability, whereby the producer is kept at arms length from transactions involving the long term commitment to transfer environmental emission removal units into the hands of another entity. One method may also include allocating a first portion of the effective environmental data to a reserve pool. The system may include providing guidance to the producer for enhancing production practices responsive to the production practice data.

Another aspect of the system can enable multi-national emitters that purchase environmental emission reductions to purchase them in one governance jurisdiction and to transfer them internally to another division (in another governance jurisdiction) to achieve a lower overall compliance cost than might otherwise be possible. Methods within the system may include contracting to transfer the title of a plurality of environmental emission reductions within a time period, which may include allocating at least a portion of the reserve pool for mitigating transfer risk, and/or assigning title to at least a portion of the reserve pool for mitigating transfer risk, and/or transferring title for at least a portion to an escrow account.

Methods within the system may include contracting to transfer the title of a plurality of environmental emission reductions within a time period, making it possible to enter into forward sale contracts. With the system making it possible to take title to a producer's data, producer risk may be severed from the obligations incurred by contracting to transfer the title of a plurality of environmental emission removal units within a time period.

Methods within the system may include the selling of one or more of a plurality of environmental emission reductions on standardized terms, which may include establishing a pool of environmental emission reductions, wherein the pool is accessed during a point of sale event for reducing at least a portion of the environmental emissions resulting from the point of sale event or service. In another example, a pool of environmental emission reductions may be established for investment purposes.

Methods within the system may include transferring the title of one or more environmental emission reductions for offsetting at least a portion of the environmental emissions from an emitter, or a plurality of emitters. Yet further, embodiments may include the allocating of environmental emission reductions from a plurality of producers of a controlling entity for offsetting at least a portion of the environmental emissions of the controlling entity.

### BRIEF DESCRIPTION OF THE DRAWINGS

Embodiments of the invention are described by way of example with reference to the accompanying drawings in which:

FIG. 1 is a diagrammatical illustration of a system embodiment including data center services and applications operable with a data capture application;

FIGS. 2A and 2B include a flow diagram illustrating one embodiment of information flow within the system, including registration and reporting, herein described by way of example;

FIG. 3 is a flow diagram illustrating a site assessment process in keeping with the teachings of the present invention;

FIG. 4 is a diagrammatical illustrating of component parts of an emission reductions serial number, by way of example;

FIGS. 5A-5C illustrate interactions between the data center and the data capture application, wherein FIG. 5A illustrates an engagement results delivery process, FIG. 5B illustrates an engagement data retrieval process, and FIG. 5C illustrates a global and status data retrieval process;

FIG. 6 is a flow diagram illustrating a process embodiment for eligibility and data testing;

FIG. 7 is a flow diagram illustrating a process embodiment for a unit creation and allocation process;

FIG. 8 is a flow diagram illustrating a process embodiment for creating emission reductions serial numbers;

FIG. 9 depicts an exemplary emission reductions certificate with serial numbers;

FIGS. 10-12 include flow diagrams illustrating inventory, search and registry, and sale process flows, respectively, for the system herein described by way of example; and

FIG. 13 is a flow diagram illustrating a process embodiment for using emission reductions serial numbers.

### DETAILED DESCRIPTION

The present invention will now be described more fully hereinafter with reference to the accompanying drawings, in which embodiments of the invention are shown, by way of example. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

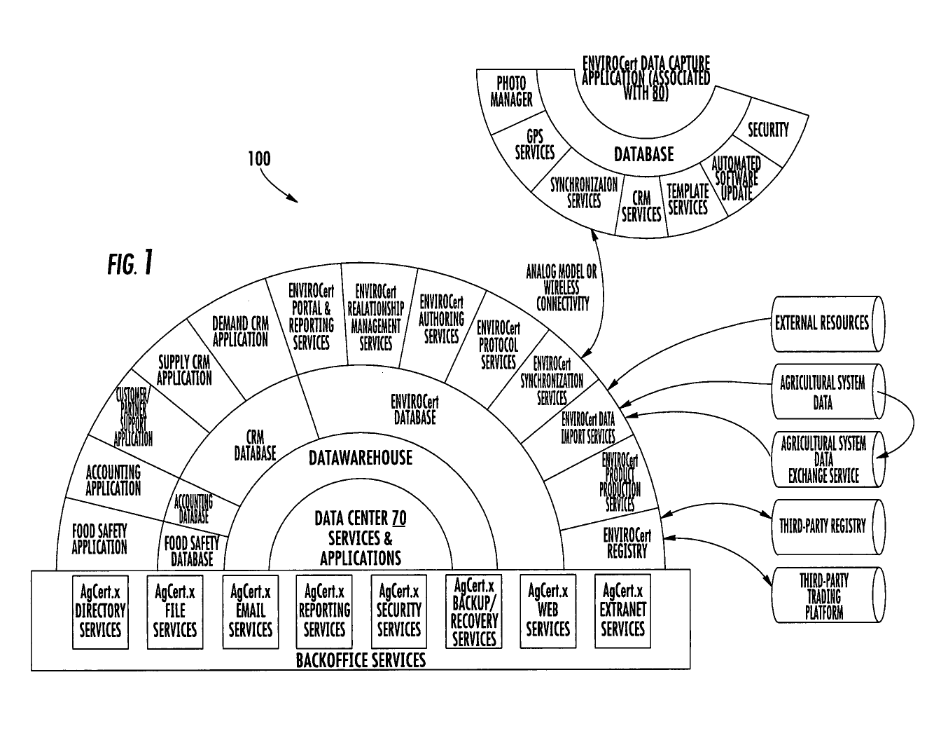

Referring initially to FIG. 1, embodiments of the present invention will provide a system 100 for tracking environmental performance of a producer of environmental emissions and of associating individual environmental emission reductions to their producer and/or to a variety of collected data 10. As illustrated with reference to FIG. 1, system 100 is comprised of various data 10, applications, and modules including data center services and applications and a data capture application, including connectivity between them. The exemplary graphic depicts services embodied both within the data center 70 and the data capture device 80.

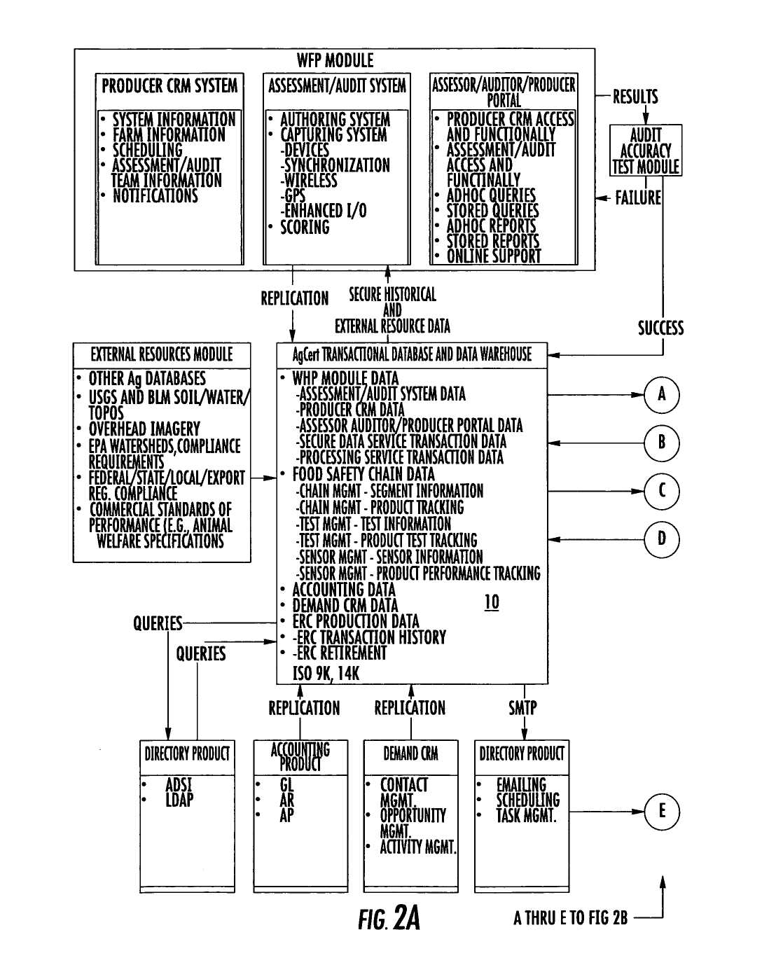

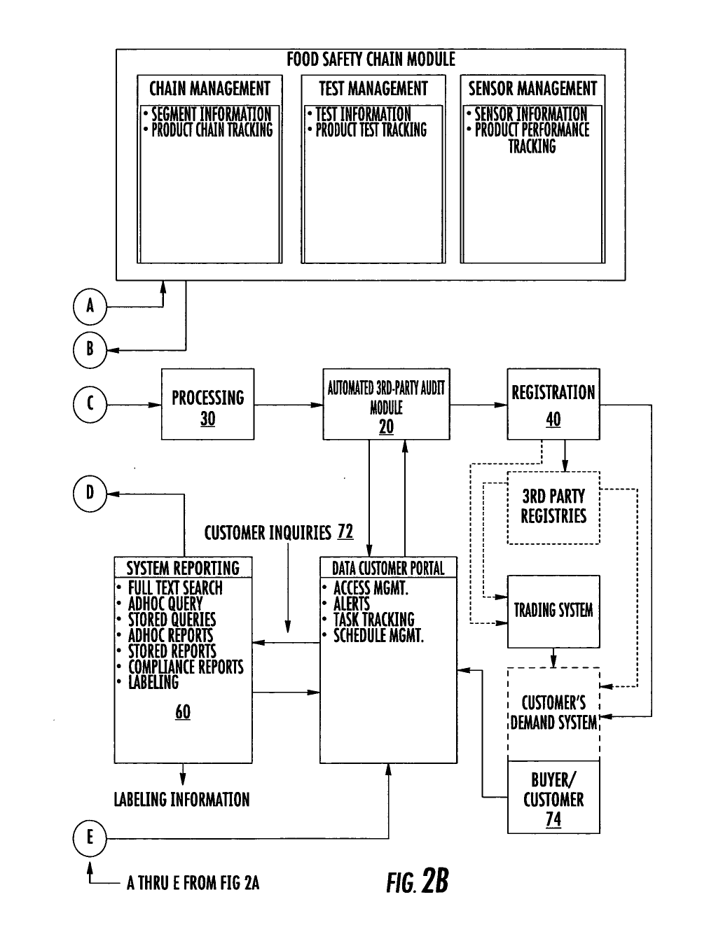

FIGS. 2A and 2B, illustrate, by way of example, system level data and data flow interactions between collected data 10 and various function modules including customer relationship management, auditing 20, processing/conversion 30, registration 40, reporting 60, accounting, various product modules, and customer inquiries.

Such a system 100 complements the use of sound foundational science used to qualify and quantify environmental emission reductions and removals, and provides means to associate registered producer environmental emission reductions with data 10 used to qualify and quantify the environmental emission reductions, to ascertain a producer's production practice baseline (of value when governance bodies are considering baseline policy changes), and for qualified entities—such as third party verifiers—to access all pertinent information relating to the qualification and quantification of the environmental emission reductions including data 10 that may have been optionally encrypted. It also provides means for prospective customers or buyers 74 as will hereafter be identified by way of example, to identify and/or reserve environmental emission reductions meeting specific sort criteria, to reconcile emitter emissions with use of emissions offsets, and to record and track environmental emission reductions unit retirement.

An embodiment of the invention includes selecting a production practice 5, selecting a protocol 8 applicable with the production practice 5 for determining at least one of environmental emissions and environmental emission reductions, collecting production practice data 10 for a pre-selected time period responsive to the protocol 8, converting the production practice data 30 to environmental data using pre-selected conversion factors, designating a geographical reference for the production practice 5, and assigning an identifier 52 to resulting environmental emission reductions.

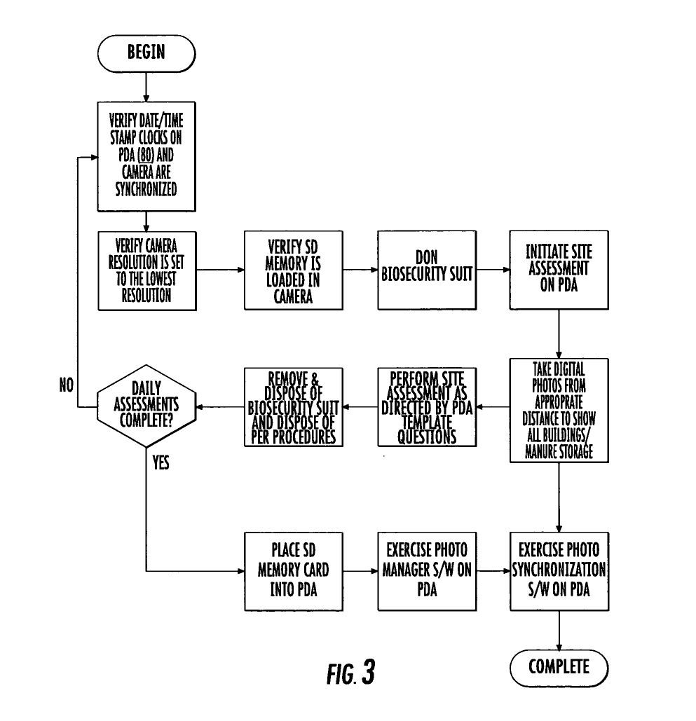

An exemplary site assessment flow, including use of an electronic data capture system 80 and collecting of production practice data 10, is illustrated with reference to FIG. 3.

An embodiment of the invention includes selecting at least one production practice 5 from at least one of a plurality of production sectors including agriculture, forestry, petroleum and/or gas production (including enhanced oil recovery), fuel production (including ethanol production), semiconductor manufacturing, metal production, coal production, deep geologic sequestration, durable goods manufacturing, and waste management (including landfills).

An embodiment of the invention includes selecting a protocol 8 appropriate to the production practice 5, collecting available external information sources 10 regarding the producer and its operations, and may include having a producer warrant the data and/or data collecting process. Specific protocols 8 may acknowledge or document the production of co-benefits along with the generation of environmental emission reductions.

Methods may include collecting production practice data 10, which are later processed 30 to qualify and quantify environmental emission removal units. The collecting of production practice data 10 may include gathering externally available information and onsite data regarding the producer.

One embodiment may include forming an assessment team for collecting information 10 regarding the production practice(s) 5, the protocol(s) 8, and prerequisite qualifications and certifications for assessors. Data collecting equipment may include the use of electronic data instruments 80, such as a PDA, that may enhance the process of collecting and transferring data 10 in a reliable, efficient manner. It is possible to use such electronic data instruments 80 to collect a producer's warrant that proper site data collecting and security procedures were followed, which forms the basis of a release of legal liability relative to specific issues. In the case of an agricultural producer, for instance, the warrant may certify that a data collecting entity followed proper bio-security protocols. For any production practice 5, this warrant can certify that data provided by the producer is accurate and complete.

In an embodiment of the invention, the pre-selected time period may comprise a calendar year for the production practice 5. It will be most important to be able to identify the production practice pre-selected time, as different environmental emission offset trading regimes are likely to have differing usage and/or reconciliation requirements relative to use of environmental emission reductions produced contemporaneously or in the past. Even in the absence of restrictions, however, buyers 74 may assign higher market value to “newer” environmental emission reductions. As well, this feature will also be of use for specific types of environmental emission reductions, wherein “permanence” is an issue, as it may be necessary to apply a temporal conversion predicated upon “permanence” curves wherein the value on an environmental emission removal unit declines as a function of time.

In one method embodiment practice data converting or processing 30 may include the protocol having conversion factors selected from the group including GHG emissions, providing clean water credits, providing clean air credits, providing soil erosion credits, and certifying animal welfare or other commercial production compliance standards. In the case of agricultural production practices, for instance, the GHG reducing may include selecting conversion factors from parameters including effluent loading, quantity of animals, manure containment storage period, manure containment storage practice, and annual animal throughput. For petroleum production processes, conversion factors may be selected from flaring volume, flaring efficiencies, and gas types and generation rates. In chemical production practices, conversion factors may be selected from chemical manufacturing efficiencies and emissions.

Converting the effective environmental data to an environmental emission reduction includes converting to an offset, credit, or allowance, depending on restrictions imposed by the relevant environmental (emission) regime, and may include choosing a registry (or registering) jurisdiction, including to enable the “use” of the environmental emission reductions in a particular jurisdiction. Further, the system 100 can associate (external) registry designators/identifiers to a specific registry jurisdiction and associates such registry designators with stored production practice data 10 and converted data, to facilitate searching the database using an external designator as the search field.

In another embodiment of the invention, the geographical reference includes a location representative of the production practice. This reference can include a nominal site location, a building or field location, or the legal address of the production practice. A buyer 74 may desire to favor environmental emission reduction supply from a particular region or producer for public relations purposes. By the same token, a buyer 74 may be unable to use environmental emission reductions from other geographic locations for reasons of regulation or policy. A geographical reference can be used by the system 100 to associate or reserve specific environmental emission reductions capacity for specific use.

In another embodiment of the invention, the geographical reference is identified by longitude and latitude.

In another embodiment, the collecting of production practice data 10 includes the contemporaneous recording of the time the data was recorded. This makes it possible for the system 100 to plot at least one of time and/or geographic location for data collecting, which can be of great use to third party verifiers or other entities who want to review the data collecting process.

An identifier may include a sequence portion characterizing a succession thereof, a vintage portion characterizing a pre-selected time period for the production practice, and a characterizing portion distinguishing at least one of geographical reference and the protocol. In this manner, individual units (or sub-units) of environmental emission reductions can be uniquely enumerated, including the year the production practice was undertaken, and additional references such as geographic reference that can be associated with an individual producer. As earlier noted, such enumeration may have keen value to buyers 74 who desire to use environmental emission reductions from specific sources or classes of sources. The system 100 also has the capacity to identify and/or reserve environmental emission reductions with specific sequence attributes.

In another embodiment of the invention, one or more of the sequences, such as the geographic reference, may be encrypted. This feature could be used to protect the privacy of specific producers, for instance, from all except those entities who are authorized to receive decrypted data. This feature could also be used to prevent one entity from “poaching” producer suppliers from another entity that seeks to have producer suppliers of environmental emission reductions.

Further, the characterizing portion of the identifier may include at least one of a first field identifying a protocol type, a second field identifying a version of the protocol, and a third field identifying an authority for the protocol. As earlier noted, specific enumeration of environmental emission reductions may be quite valuable to specific buyers 74. For example, the protocol type will directly or indirectly identify the production practice responsible for creating the environmental emission reduction. As well, a specific protocol version may, for example, treat data variance or data collection/monitoring (or some other attribute specified by the protocol) in a “preferable” way (viewed from the perspective of the buyer 74). Lastly, a field identifying approval authority could enable a buyer to choose environmental emission reductions that have been approved by a specific entity, such as a government or the World Bank. Forearmed with this knowledge, a buyer 74 could selectively choose to purchase specific environmental emission reductions, to complement a business typology, a compliance philosophy, to favor a given approval authority, or so forth.

In yet another embodiment of the invention, the environmental emission reduction comprises a plurality of environmental emission reductions resulting from the environmental data converting 30, wherein a sequence portion of the identifier includes a range of sequence numbers representing the plurality of environmental emission reduction units.

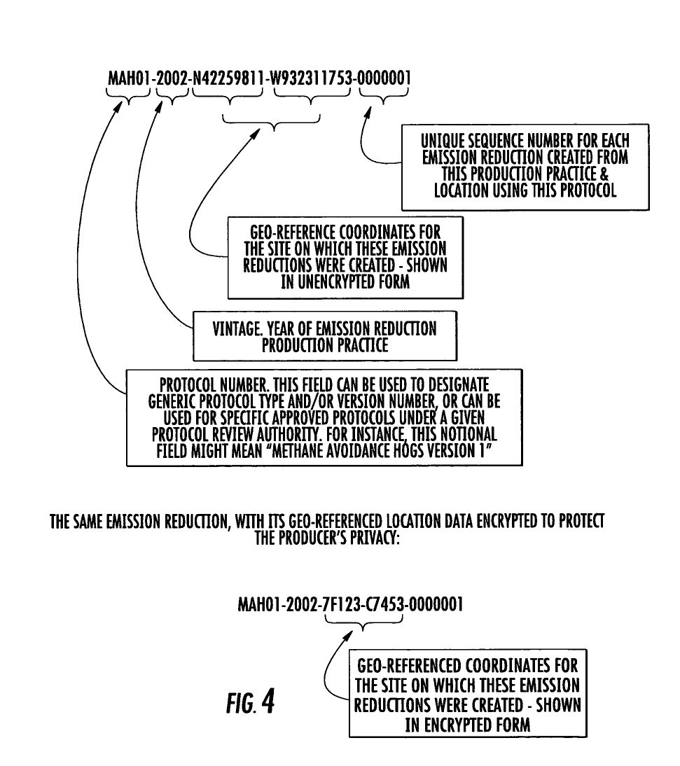

FIG. 4 is exemplary of a serial number broken into component parts, wherein individual sequences are shown for illustration. In this example, an identifier 52 is a serial number comprised of a protocol identifier field, a vintage field, a geo-location reference, and a sequence section. Both encrypted and unencrypted versions of the geo-location reference are shown.

The system 100 may include transferring the production practice data to a data center, wherein transferring data may include transmitting and/or encrypting the production practice data, and receiving the production practice data, which may include decrypting the production practice data and/or securing the data and restricting access.

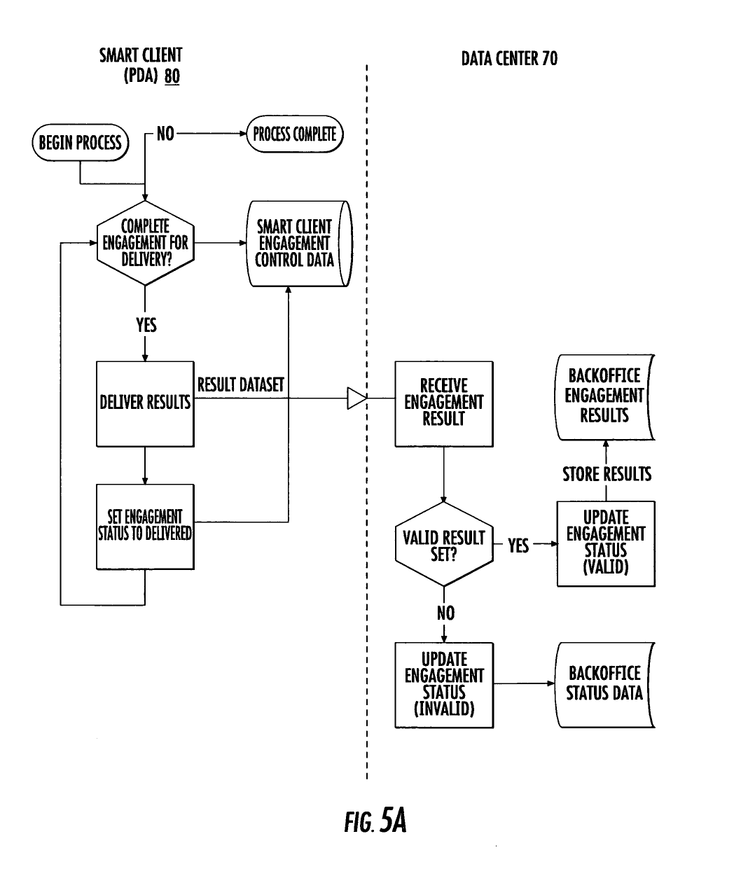

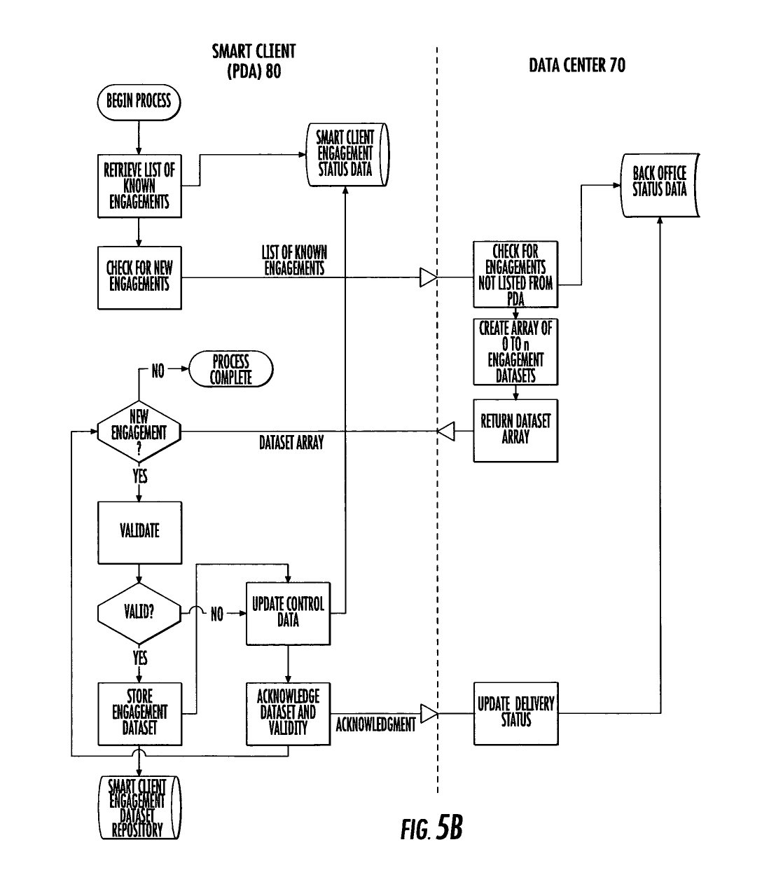

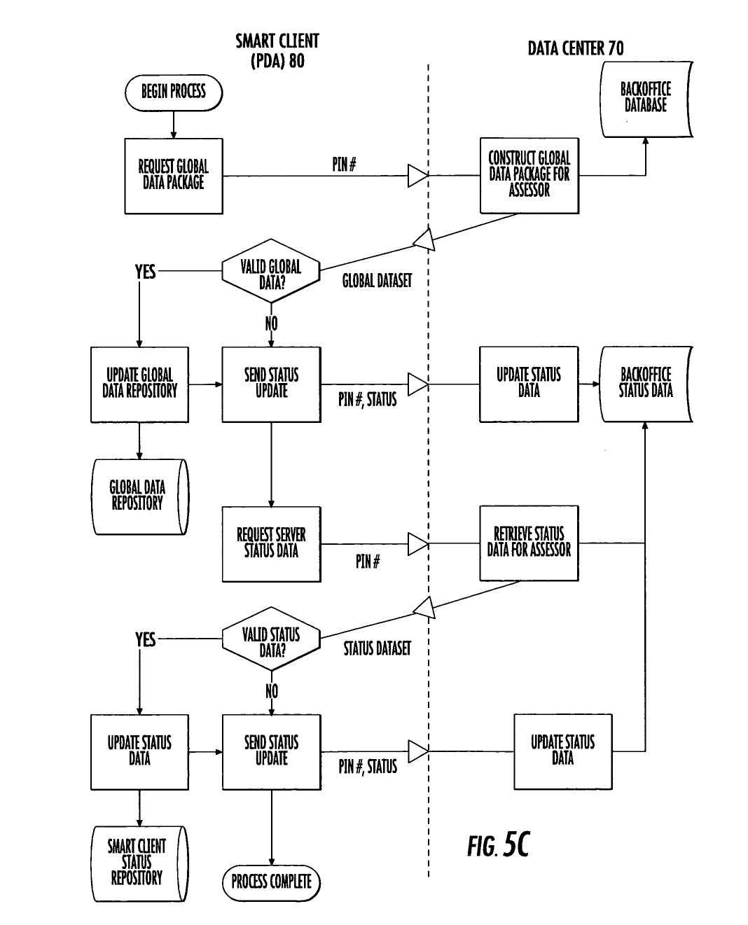

FIGS. 5A-5C illustrate, by way of example, interactions between the data center 70 and the data capture device/application 80, wherein FIG. 5A documents an engagement results delivery process, FIG. 5B illustrates an engagement data retrieval process, and FIG. 5C illustrates a global and status data retrieval process.

Methods may include confirming that the received production practice data meets a pre-selected data standard, including data integrity, data completeness, storing the data and/or associated identifier in a database, testing the production practice data's eligibility for processing, such tests including reviewing for non-conforming processes, and correlating the production practice data with the identifier for access thereto.

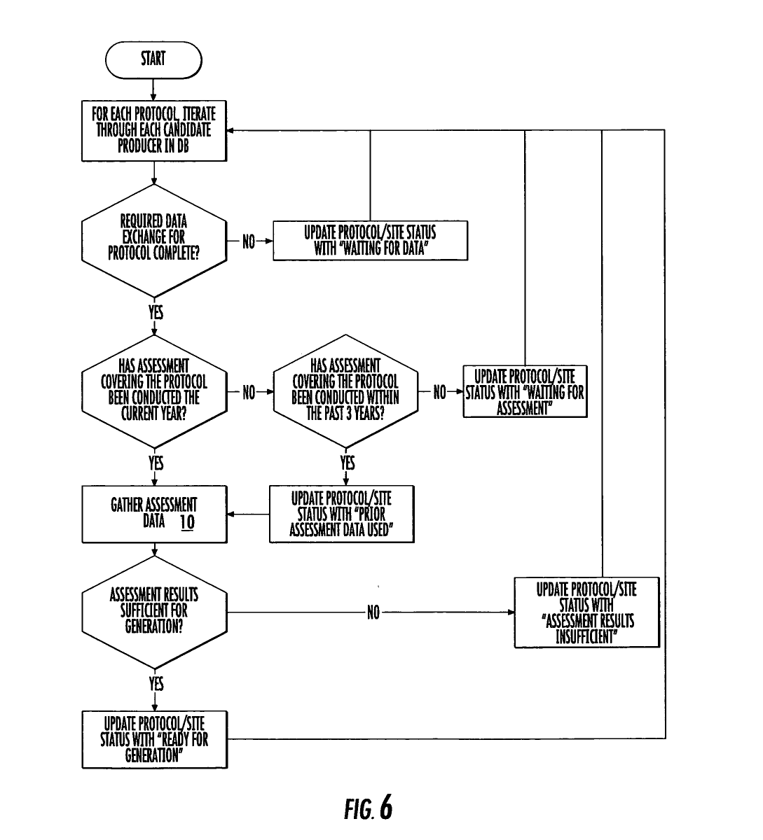

FIG. 6 is a flow diagram illustrating a process embodiment for a unit creation and allocation process.

Method steps within an embodiment of the invention may include converting the effective environmental data and registering 40 the effective environmental data to an environmental emission removal unit. Registering 40 of data may include verifying the commercial suitability of the effective environmental data, recording the registering, designating the ownership of the environmental emission reductions, assigning a unique identifier 52, which may be a protocol related identifier, may provide either temporal or spatial information regarding the production practice that caused the environmental emission reductions to be created (including geo-referenced coordinates), may include specific emission removal unit accounting, or which may include full or partial encryption, and includes the case wherein a unique identifier 52 may consist of a serial number, which may be derived relating to such parameters as those mentioned herein. In another example, registering 40 may include designating ownership of at least a portion of the plurality of registered environmental emission reductions, and include monitoring of all transactions thereof.

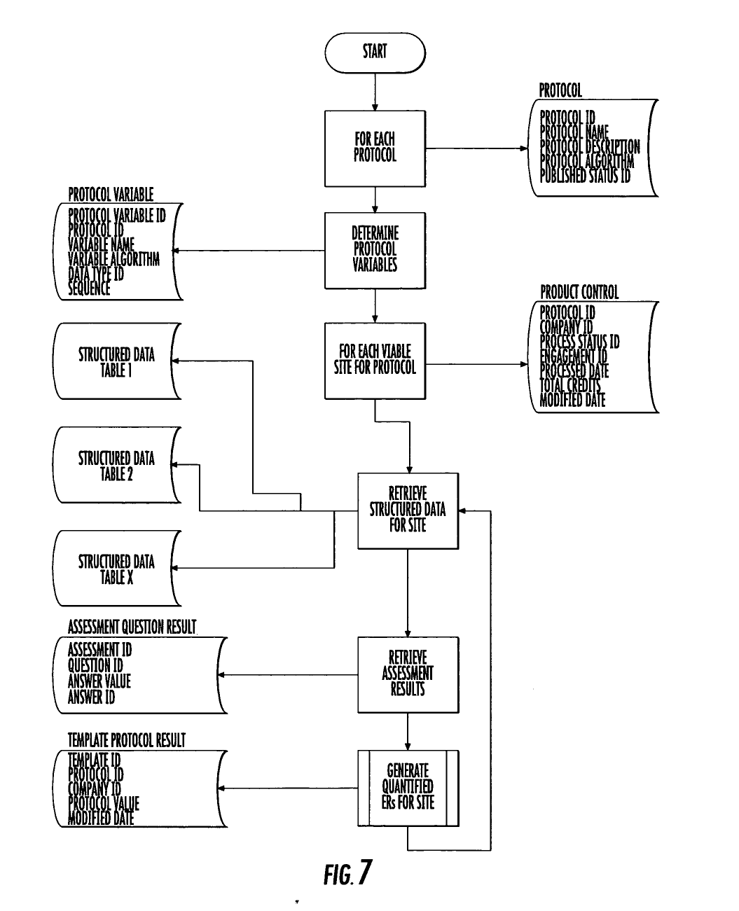

FIG. 7 is a flow diagram illustrating a process embodiment for a unit creation and allocation process.

Method steps within an embodiment of the invention may include transferring at least a portion of the plurality of environmental emission units/reductions and providing a transaction verification therewith, wherein the transaction verification includes the identifier 52 for each of the at least a portion thereof. In one example, the transaction verification includes having a certificate having the identifier 52 carried thereon. In this example, the identifier 52 may provide information regarding the time period, the geographical reference, and a sequence for each of the environmental emission reductions being transferred.

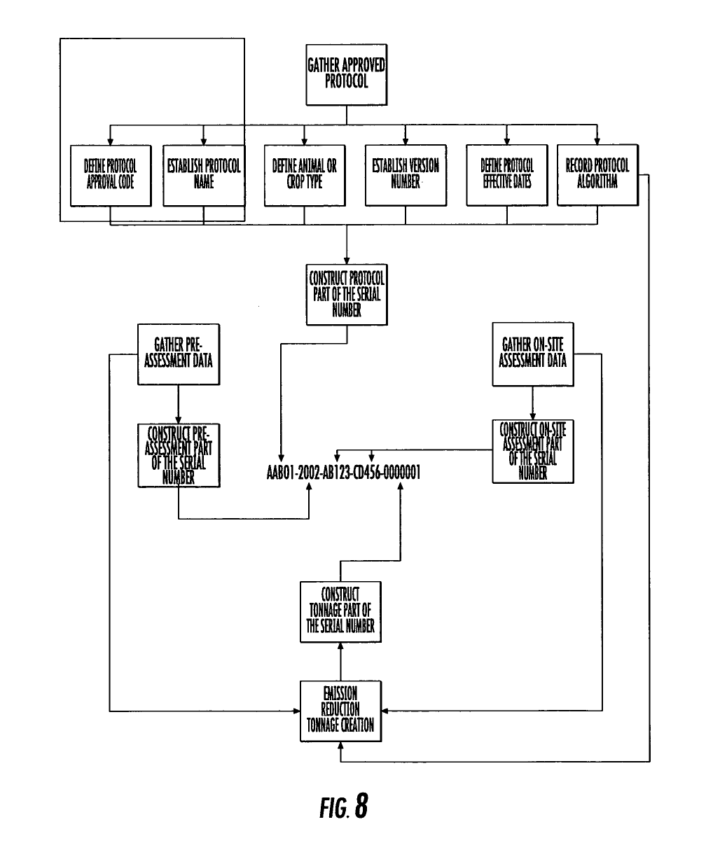

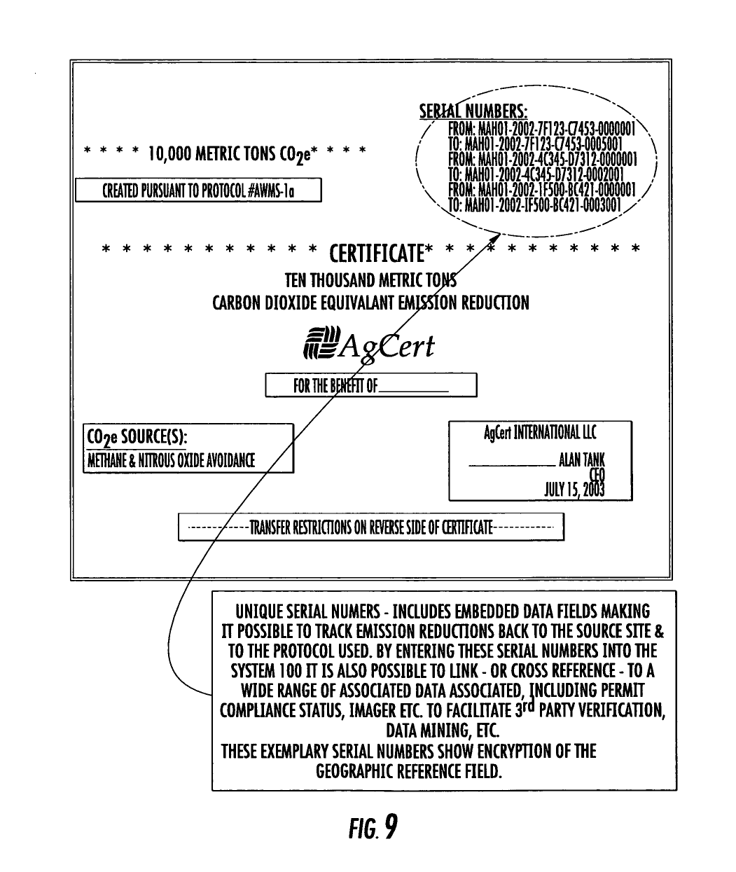

A serial number creation process is illustrated with reference to FIG. 8, wherein the production practice is agricultural. A sample environmental emission reductions certificate is illustrated with reference to FIG. 9, wherein one or more successions of identifiers 52, in this case serial numbers, are used to designate an aggregate capacity being transferred via the certificate. In this example, the geographical reference has been encrypted to protect the identity of the producers involved. This certificate can be considered analogous to a stock certificate, wherein the named beneficiary is considered the holder of the designated environmental emission reductions.

The system 100 may be used to associate an externally assigned identifier to internal data and/or identifiers. In addition, all collected data 10 relative to one or more environmental emission removal units may be correlated.

Methods may include selling, transferring, or retiring the environmental emission reduction unit(s).

A method within an embodiment of the invention further comprises transferring the environmental emission reduction(s) for offsetting at least a portion of an environmental emission.

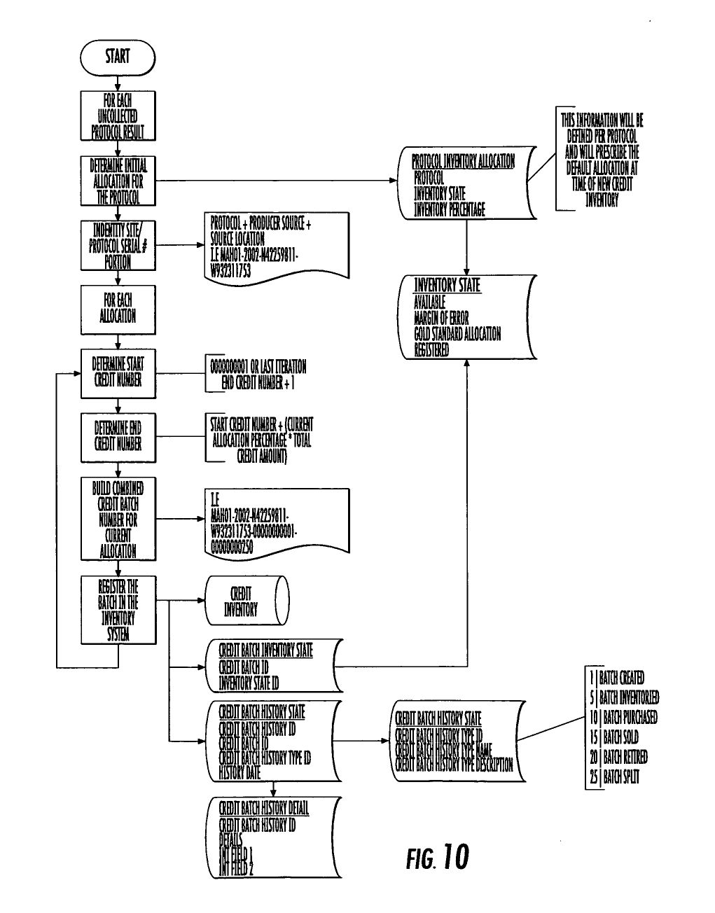

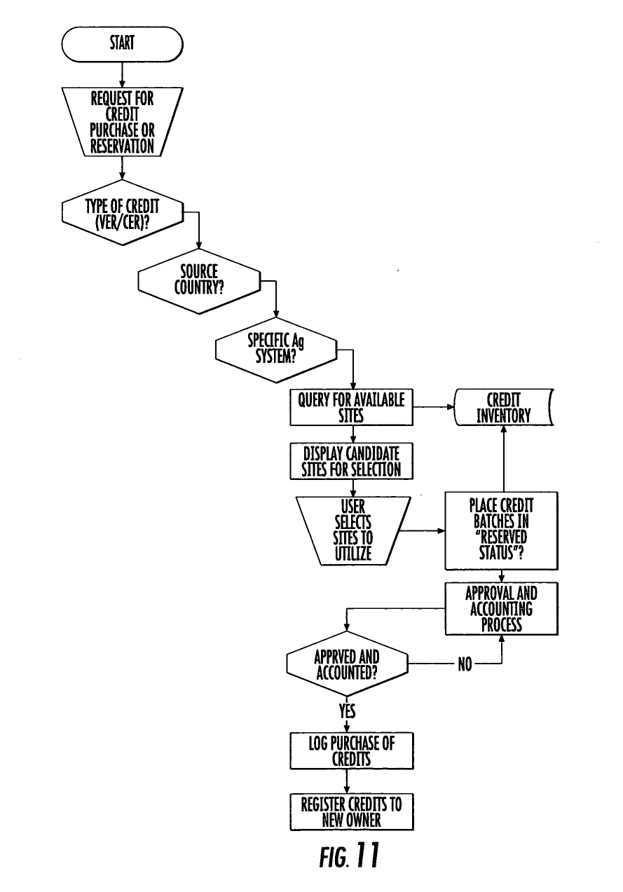

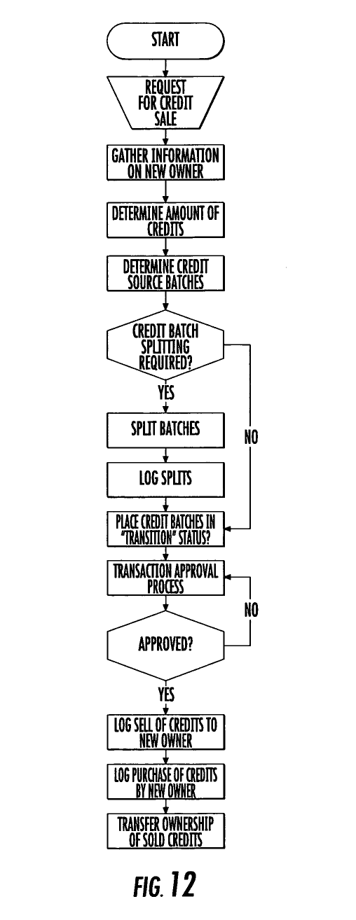

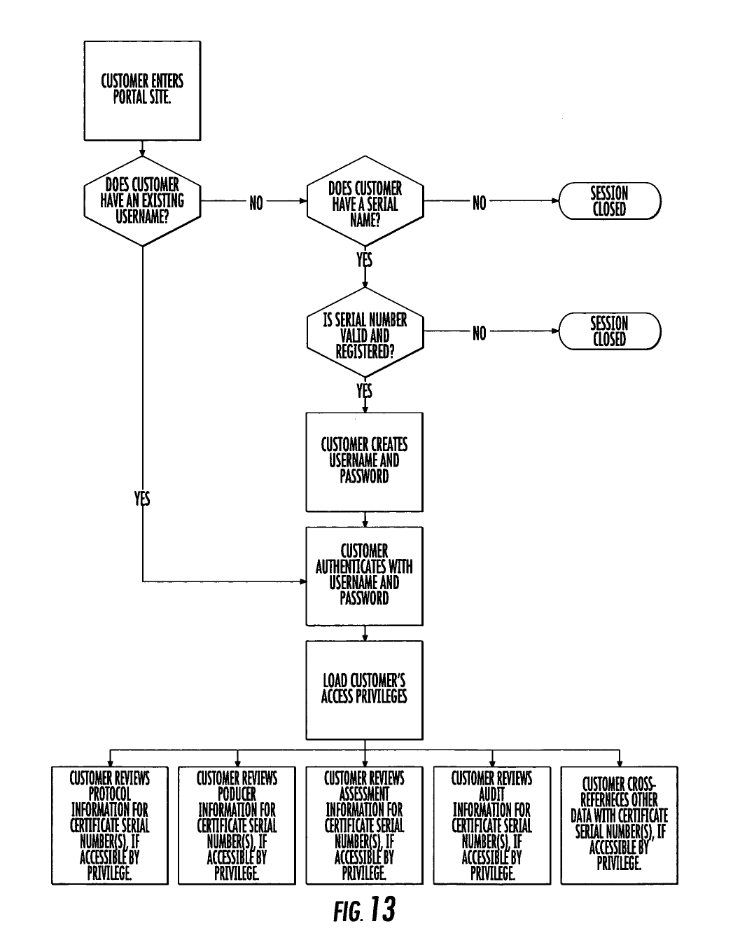

The system 100 can be queried by authorized entities, such as third party verifiers or customers 74, to determine and report on specific production practice data, associated identifiers, and/or associated environmental emission reductions, or on compliance issues, relating any production practice data contained in the data warehouse or available through external sources. FIGS. 10-12 include flow diagrams illustrating inventory, search and registry, and sale process flows, respectively, for the system 100 herein described by way of example. The use of a serial number to query the data center 70 is illustrated with reference to FIG. 13, wherein a user is required to enter a password to authenticate use of the system and then enters an environmental emission reduction serial number to review associated data and status information.

The taking of title to the effective environmental data by an entity other than the producer makes it possible to sever producer liability, whereby the producer is kept at arms length from transactions involving the long term commitment to transfer environmental emission removal units into the hands of another entity. One method may also include allocating a first portion of the effective environmental data to a reserve pool 44. The system may include providing guidance to the producer for enhancing production practices responsive to the production practice data.

Another aspect of the system 100 can enable multi-national emitters that purchase environmental emission reductions to purchase them in one governance jurisdiction and to transfer them internally to another division (in another governance jurisdiction) to achieve a lower overall compliance cost than might otherwise be possible. Methods within the system may include contracting to transfer the title of a plurality of environmental emission reductions within a time period, which may include allocating at least a portion of the reserve pool 44 for mitigating transfer risk, and/or assigning title to at least a portion of the reserve pool 44 for mitigating transfer risk, and/or transferring title for at least a portion to an escrow account.

Methods within the system may include contracting to transfer the title of a plurality of environmental emission reductions within a time period, making it possible to enter into forward sale contracts. Because the system 100 makes it possible to take title to a producer's data 10, it is possible to sever producer risk from the obligations incurred by contracting to transfer the title of a plurality of environmental emission removal units within a time period.

Methods within the system may include the selling of one or more of a plurality of environmental emission reductions on standardized terms, which may include establishing a pool 46 of environmental emission reductions, wherein the pool 46 is accessed during a point of sale event for reducing at least a portion of the environmental emissions resulting from the point of sale event or service. In another example, a pool 46 of environmental emission reductions may be established for investment purposes. In yet another example the environmental emission results from at least one of an emitter, a plurality of emitters, and a variety of emitters, wherein the emitter is at least one of a direct emitter and an indirect emitter.

Methods within the system 100 may include allocating at least a portion of the plurality of environmental emission reductions to a producer of environmental emissions for an offsetting thereof.

Methods within the system may include transferring the title of one or more environmental emission reductions for offsetting at least a portion of the environmental emissions from an emitter, or a plurality of emitters. Yet further, embodiments may include the allocating of environmental emission reductions from a plurality of producers of a controlling entity for offsetting at least a portion of the environmental emissions of the controlling entity.

1. A method of tracking environmental performance of a producer of environmental emissions, the method comprising:
selecting a production practice of the producer;
selecting a protocol applicable with the production practice for determining at least one of environmental emissions and environmental emissions removal;
collecting production practice data of the producer for a pre-selected time period responsive to the protocol;
converting the production practice data to environmental data using pre-selected conversion factors;
designating a geographical reference for the producer;
converting the environmental data to an emission reduction unit for a transferring thereof; and
assigning an identifier to the emission reduction unit, wherein the identifier includes a sequence portion characterizing a succession thereof and a vintage portion characterizing the pre-selected time period for the production practice, and a characterizing portion characterizing at least one of the geographical reference and the protocol.

2. A method according to claim 1, wherein the characterizing portion of the identifier includes at least one of a first field identifying a protocol type, a second field identifying a version of the protocol, and a third field identifying an authority for the protocol.

3. A method according to claim 1, wherein the pre-selected time period comprises a calendar year for the production practice by the producer.

4. A method according to claim 1, wherein the geographical reference includes a location representative of the production practice.

5. A method according to claim 4, wherein the location is identified by a longitude and latitude.

6. A method according to claim 1, wherein the emission reduction unit comprises a plurality of emission reduction units resulting from the environmental data converting, and wherein the sequence portion of the identifier includes a range of sequence numbers representing the plurality of emission reduction units.

7. A method according to claim 1, wherein the production practice data converting includes the protocol having conversion factors selected from the group including reducing GHG emissions, providing clean water credits, providing clean air credits, providing soil erosion credits, and certifying animal welfare.

8. A method according to claim 7, wherein the GHG reducing includes a parameter selected from parameters including effluent loading, quantity animals, manure containment storage period, manure containment storage practice, annual animal throughput, flaring volume, flaring efficiencies, gas types and generation rates, and chemical manufacturing efficiencies and emissions.

9. A method according to claim 1, further comprising:
transmitting the production practice data to a data center; and
receiving the production practice data at the data center;

10. A method according to claim 1, further comprising:
storing the identifier in a database;
storing the production practice data in the database; and
correlating the production practice data with the identifier for access thereto.

11. A method according to claim 10, further comprising:
providing a password for accessing the database;
accessing the database using the password;
providing the identifier of the emission reduction unit; and
receiving a status regarding the emission reduction unit.

12. A method according to claim 1, further comprising at least one of selling, transferring, exchanging, and retiring the emission reduction unit.

13. A method according to claim 1, further comprising warranting the production practice data by the producer.

14. A method according to claim 1, further comprising registering the emission reduction unit.

15. A method according top claim 14, further comprising at least one of verifying a commercial suitability of the environmental emission unit, recording the registering, designating ownership of the environmental emission unit, and monitoring a transaction thereof.

16. A method according to claim 1, wherein the identifier is a serial number.

17. A method according to claim 1, wherein the converting to the emission reduction unit includes at least one of using the emission reduction unit for an environmental offset, a credit, and allowance.

18. A method according to claim 1, wherein the converting to an emission reduction unit includes choosing a registry jurisdiction.

19. A method according to claim 18, further comprising assigning a registry designator to the emission reduction unit and correlating the registry designator to the registry jurisdiction.

20. A method according to claim 19, further comprising:
storing the registry designator, identifier, and production practice data;
correlating the registry designator with the identifier and the identifier with the production practice data for access thereto.

21. A method according to claim 20 further comprising:
providing a password for retrieving the registry designator; and
receiving a status regarding at least one of the emission reduction unit and the production practice data.

22. A method according to claim 1, further comprising transferring the emission reduction unit and providing a transaction verification therewith, wherein the transaction verification includes the identifier of the emission reduction unit.

23. A method according to claim 22, wherein the transaction verification includes a certificate having the identifier carried thereon.

24. A method according to claim 23, wherein the identifier provides information regarding the protocol, the pre-selected time period, the geographical reference, and a sequence for the emission reduction unit corresponding to the emission reduction unit transferring.

25. A method according to claim 22, further comprising establishing a pool of emission reduction units and accessing the pool during a point of sale event for reducing at least a portion of the environmental emissions resulting from the point of sale event.

26. A method according to claim 1, further comprising transferring the emission reduction unit for offsetting at least a portion of an environmental emission.

27. A method according to claim 26, wherein the environmental emission results from at least one of an emitter, a plurality of emitters, and a variety of emitters, and wherein the emitter is at least one of a direct emitter and an indirect emitter.

28. A method according to claim 1, further comprising allocating emission reduction units resulting from a plurality of producers controlled by a controlling entity for offsetting environmental emissions of the controlling entity.

29. A method according to claim 1, wherein environmental emissions removal is selected from a practice group consisting of sequestration, mitigation, and avoidance.

30. A method according to claim 1, further including recording a time for the production practice data collecting and a geographic location thereof.

31. A method according to claim 1, further comprising reserving an emission reduction unit having at least one of a pre-selected geographic reference, protocol, and time period.

32. A method of tracking environmental performance, the method comprising:
collecting production practice data representative of at least one of environmental emissions and environmental emissions removal for a time period;
converting the production practice data to environmental data using pre-selected conversion factors;
designating a geographical reference for the production practice;
converting the environmental data to a plurality of emission reduction units; and
assigning an identifier to each of the plurality of emission reduction units, wherein the identifier includes a sequence portion characterizing a succession thereof, a vintage portion characterizing the time period for the production practice, and a geographical reference portion characterizing the geographical reference.

33. A method according to claim 32, further comprising selecting a protocol applicable with the production practice for quantifying the at least one of the environmental emissions and the environmental emissions removal.

34. A method according to claim 33, wherein the production practice data converting includes the protocol having conversion factors selected from the group including reducing GHG emissions, providing clean water credits, providing clean air credits, providing soil erosion credits, and certifying animal welfare.

35. A method according to claim 34, wherein the GHG reducing includes a parameter selected from parameters including effluent loading, quantity animals, manure containment storage period, manure containment storage practice, annual animal throughput, flaring volume, flaring efficiencies, gas types and generation rates, and chemical manufacturing efficiencies and emissions.

36. A method according to claim 33, wherein the characterizing portion of the identifier includes at least one of a first field identifying a protocol type, a second field identifying a version of the protocol, and a third field identifying an authority for the protocol.

37. A method according to claim 32, wherein the time period comprises a calendar year for the production practice.

38. A method according to claim 32, wherein the geographical reference includes a location representative of the production practice.

39. A method according to claim 32, further comprising:
storing the identifier in a database;
storing the production practice data in the database; and
correlating the production practice data with the identifier for access thereto.

40. A method according to claim 32, further comprising at least one of selling, transferring, exchanging, and retiring at least a portion of the plurality of emission reduction units.

41. A method according top claim 32, further comprising at least one of:
verifying a commercial suitability of at least a portion of the plurality of environmental emission units;
registering at least a portion of the plurality of emission reduction units with a registry;
designating ownership of at least a portion of the plurality of emission reduction units; and
monitoring a transaction for at least a portion of the plurality of emission reduction units.

42. A method according to claim 41, further comprising assigning a registry designator to the emission reduction unit and correlating the registry designator to a registry jurisdiction.

43. A method according to claim 42, further comprising:
storing the registry designator, identifier, and the production practice data; and
correlating the registry designator with the identifier and the identifier with the production practice data for access thereto.

44. A method according to claim 32, further comprising transferring at least a portion of the plurality of emission reduction units and providing a transaction verification therewith, wherein the transaction verification includes the identifier for each of the at least a portion thereof.

45. A method according to claim 44, wherein the transaction verification includes a certificate having the identifier carried thereon.

46. A method according to claim 45, wherein the identifier provides information regarding time period, the geographical reference, and a sequence for each of the emission reduction units being transferred.

47. A method according to claim 32, wherein the environmental emission results from at least one of an emitter, a plurality of emitters, and a variety of emitters, and wherein the emitter is at least one of a direct emitter and an indirect emitter.

48. A method according to claim 32, further comprising allocating at least a portion of the plurality of emission reduction to a producer of environmental emissions for an offsetting thereof.

49. A method according to claim 32, further including recording a time for the production practice data collecting and a geographic location thereof.

50. A method according to claim 32, further comprising reserving an emission reduction unit having at least one of a pre-selected geographic reference, protocol, and time period.

51. A method of tracking environmental emissions, the method comprising:
selecting a production practice;
selecting a protocol applicable with the production practice for quantifying at least one of environmental emissions and environmental emissions removal;
collecting production practice data for a pre-selected time period responsive to the protocol;
converting the production practice data to environmental data using the protocol;
designating a geographical reference for the production practice;
converting at least a portion of the environmental data to a plurality of emission reduction units; and
assigning an identifier to each of the plurality of emission reduction units, wherein the identifier includes a sequence portion characterizing a succession thereof and a vintage portion characterizing the pre-selected time period for the production practice, and a characterizing portion characterizing at least one of the geographical reference and the protocol.

52. A method according to claim 51, wherein the characterizing portion of the identifier characterizing the protocol includes a first field identifying a protocol type, a second field identifying a version of the protocol, and a third field identifying an authority for the protocol.

53. A method according to claim 51, wherein the geographical reference includes a location representative of the production practice.

54. A method according to claim 51, wherein the production practice data converting includes the protocol having conversion factors selected from the group including reducing GHG emissions, providing clean water credits, providing clean air credits, providing soil erosion credits, and certifying animal welfare.

55. A method according to claim 54, wherein the GHG reducing includes a parameter selected from parameters including effluent loading, quantity animals, manure containment storage period, manure containment storage practice, annual animal throughput, flaring volume, flaring efficiencies, gas types and generation rates, and chemical manufacturing efficiencies and emissions.

56. A method according to claim 51, further comprising:
storing the production practice data to a database;
storing the identifier in the database; and
correlating the production practice data with the identifier for access thereto.

57. A method according to claim 56, further comprising:
providing a password for accessing the database;
accessing the database using the password;
providing the identifier for at least one of the plurality of emission reduction units; and
receiving a status report for the at least one of the plurality of emission reduction units.

58. A method according to claim 57, further comprising registering at least a portion of the plurality of emission reduction units within a registry jurisdiction for providing a plurality of registered units.

59. A method according to claim 58, further comprising at least one of selling, transferring, exchanging, and retiring at least a portion of the plurality of registered units.

60. A method according top claim 59, further comprising:
designating ownership of at least a portion of the plurality of registered units; and
monitoring a transaction thereof.

61. A method according to claim 58, further comprising assigning a registry designator to the emission reduction unit and correlating the registry designator to the registry jurisdiction.

62. A method according to claim 61, further comprising correlating the registry designator with the identifier.

63. A method according to claim 67, further comprising:
providing a password for retrieving the registry designator; and
receiving a status regarding at least one of the plurality of registered units.

64. A method according to claim 58, further comprising providing a transaction verification for each of the plurality of registered units transferred out of the registry.

65. A method according to claim 64, wherein the transaction verification includes a certificate having the identifier carried thereon.

66. A method according to claim 51, further including recording a time for the production practice data collecting and a geographic location thereof.

67. A method according to claim 51, further comprising reserving an emission reduction unit having at least one of a pre-selected geographic reference, protocol, and time period.
